(19) United States
(12) Patent Application Publication
(10) Pub. No.: US 2013/0331972 A1
(43) Pub. Date: Dec. 12, 2013

(54) SYSTEM AND METHOD FOR SYNCHRONIZING AN APPLICATION WITH AUDIO CONTENT

(71) Applicants: Jacques Sagne, Paris (FR); Rémi Pecqueur, Puteaux (FR)

(72) Inventors: Jacques Sagne, Paris (FR); Rémi Pecqueur, Puteaux (FR)

(73) Assignee: Egonocast, Paris (FR)

(21) Appl. No.: 13/883,678

(22) PCT Filed: Oct. 21, 2011
(86) PCT No.: PCT/EP2011/068415

§ 371 Date: Jun. 21, 2013

(30) Foreign Application Priority Data
Nov. 15, 2010 (FR) 10/29347

(51) Int. Cl. G06F 17/30

(52) U.S. Cl. CPC G06F 17/3074
USPC 700/94

(57) ABSTRACT

An application is to be synchronised with an audio content intended to be consumed by a consumer terminal. The content is provided in the form of a stream of audio data time-stamped according to a first time reference. The application is executed according to a second time reference. Synchronising the application with the audio content comprises steps of: obtaining (6.4) audio data of said time-stamped content, on the basis of the second time reference, in order to indicate respective instants at which said audio data is consumed by said consumer terminal; determining (6.6) information on the correlation between the audio data; determining (6.7) information on the time offset between the first and second time references on the basis of the determined correlation information and of data time-stamping information; and synchronising the application with said content on the basis of this time-offset information.

The present invention concerns the synchronisation of an application installed on a terminal, referred to as interactivity terminal, with an audio content intended to be consumed by a terminal, referred to as consumer terminal, said content being provided in the form of a stream of audio data time-stamped according to a first time reference, said application being executed according to a second time reference.

Mobile terminals such as mobile phones, and in particular high-end telephones (also called smartphones), personal digital assistants (PDAs), personal computers of the tablet type (tablet PC or electronic tablet), and more generally all mobile or portable terminals provided with multimedia capabilities are examples of interactivity terminals. These terminals offer ever more numerous functionalities to their users. These functionalities are accessible in the form of software modules called applications. Because of the extent of the functionalities that they offer, these mobile interactivity terminals are de facto becoming a favoured interface for interacting with a user.

Although these mobile interactivity terminals generally enable displaying audiovisual contents, the user normally prefers, in a domestic environment, to view such contents on a screen, optionally connected to a decoding box (set-top box) for receiving broadcast content. This is because the dimensions of the screen on which such contents are then displayed afford a better user experience. A consumer terminal is then spoken of Examples of consumer terminals are television sets, comprising a screen and loudspeakers, or loudspeakers serving to broadcast sound when they are not integrated with the screen, or any other audio system.

In order to enhance this user experience, it is envisaged enabling the user to view such audiovisual contents on a screen with a size of the same order as that of current television sets, while giving him/her the possibility of interacting with these contents via a mobile interactivity terminal. In such a context, given that the mobile interactivity terminal, the set-top box and the screen, or the consumer terminal, do not have a common time reference, it is necessary to synchronise the interactivity application launched on the mobile terminal with the content displayed by the screen. This is because, for good user experience, it is necessary for the application to manage the interactivity with the user so as to be synchronised with the content displayed.

It can be noted that it does not appear desirable to effect the synchronisation of the application with the content by (i) slaving of the clock of the mobile interactivity terminal to that of the consumer terminal, and then (ii) synchronisation of the clock of the consumer terminal with that of the stream in the form of which the content is provided. This slaving could for example be implemented by using a protocol between the consumer terminal, for example the screen of the television set, and the mobile interactivity terminal, or by the use, both by the mobile interactivity terminal and by the consumer terminal, of a universal clock. This would however have the drawback of requiring either the development of protocols to be used conjointly by the mobile interactivity terminal and by the consumer terminal, which would imply interoperability difficulties, or the integration of the universal clock functionality in numerous items of multimedia equipment, which would tend to increase the cost of such equipment. In all cases, this would not enable using off-the-shelf screens (legacy displays) as consumer terminals.

In the case where the interactivity terminal and the consumer terminal are implemented by the same equipment, for example when interactive data are presented to the user actually at the screen of the television set rather than on a mobile terminal, it can be noted that a similar synchronisation problem arises. The first time reference used for time-stamping the data of the stream transporting the audiovisual content is in fact unknown to the interactivity/consumer terminal. When the data stream is received via the set-top box, and even though the first time reference used for time-stamping the audio stream broadcast could be known to this set-top box, the time offset existing between the decoding of the stream by the set-top box and the actual consumption of the data by this screen would greatly impair the user experience. In addition, it should be noted that, according to certain architectures, the interactive data would not pass through the set-top box.

It may also be noted that this synchronisation problem also arises when the content is simply an audio content rather than an audiovisual content, the terminals used being able, by way of illustration, to take the form of a mobile terminal for the interactivity terminal and a radio set for the consumer terminal.

It is desirable to overcome these various drawbacks of the prior art.

The invention concerns a system for synchronising an application with an audio content intended to be consumed by a terminal, referred to as consumer terminal, said content being provided in the form of a stream of audio data time-stamped according to a first time reference, said application being executed according to a second time reference. The system is such that it comprises: means for obtaining audio data of said content, said obtained audio data being time-stamped, on the basis of a second time reference, to indicate respective instants of consumption of said audio data by said consumer terminal; means for determining information on a correlation between said obtained audio data and said audio data of said stream; means for determining information on a time offset between the first and second time references, according to the determined correlation information and information on time-stamping of data according to the first and second time references; and means for synchronising the application with said content, on the basis of the determined time offset information. Thus, it is possible to synchronise the application without having to slave the time reference, on the basis of which it is executed, to the time reference used for the time-stamping of the data of the stream in the form of which the content is provided.

According to a particular embodiment, the application is executed on a terminal distinct from the consumer terminal and said means for obtaining audio data of said content comprise means for recording part of the audio content consumed by the consumer terminal. Thus, although the application is installed on a terminal, referred to as interactivity terminal, for which the content is not intended, it is possible to synchronise the application to the content. It is then possible for the user to use a mobile interactivity terminal for interacting in a synchronised manner with an audiovisual content processed independently by a fixed consumer terminal, such as a screen provided with loudspeakers.

According to a particular embodiment, the consumer terminal is connected to a device comprising means for recovering said content from said stream of audio data time-stamped according to the first time reference, the application is executed on the consumer terminal and the consumer terminal comprises means for generating, from said audio content, a stream of audio data time-stamped according to the second time reference. Thus, the obtained audio data are non-noisy, the result of the correlation between the audio data time-stamped according to the two time references being made reliable thereby. In this way, it is therefore possible to synchronise the application with the audio content with a negligible risk of error.

According to a particular embodiment, the system comprises means for re-sampling the obtained audio data and/or the audio data of said stream to a target frequency. Thus, it is possible to use devices whether for generating said stream or for obtaining audio data time-stamped according to the second time reference, which operate at distinct sampling frequencies.

According to a particular embodiment, said synchronisation means comprise means for taking into account said time offset information by said application. Thus, when several such applications are implemented on respective terminals, for example for a set of mobile interactivity terminals, it is possible to trigger functionalities of these applications using the same generic notification, common to all the interactivity terminals.

According to a particular embodiment, said synchronisation means comprise means for taking into account said time offset information by means of a device transmitting to said application events related to said content. Thus, it is possible to use an application that is not aware of the time offset existing between the time references. The development of such applications is thereby simplified.

According to a particular embodiment, the means for determining correlation information comprise a matched filter, based on a time reversal of said obtained audio data, or means for generating acoustic fingerprints from said obtained data and the data of said stream and for comparing the generated fingerprints. Thus, it is possible to simply and effectively perform the correlation between the audio data time-stamped according to the two time references.

According to a particular embodiment, the system comprises means for modifying the time offset information upon detecting a start of stream decoding. Thus, when a new audiovisual program is selected by the user, any time desynchronisations related to this change of context are corrected by matching the time synchronisation information.

According to a particular embodiment, said audio content forms part of an audiovisual content.

The invention also concerns a method for synchronising an application with an audio content intended to be consumed by a terminal, referred to as consumer terminal, said content being provided in the form of a stream of audio data time-stamped according to a first time reference, said application being executed according to a second time reference. The method is such that it comprises steps of: obtaining audio data of said content, said obtained audio data being time-stamped, on the basis of the second time reference, to indicate respective instants of consumption of said audio data by said consumer terminal; determining information on correlation between said obtained audio data and said audio data of said stream; determining information on a time offset between the first and second time references, according to the correlation information determined and information on time-stamping of the data according to the first and second time references; synchronising the application with said content, on the basis of the determined time offset information.

The invention also concerns a device determining offset information intended to synchronise an application with an audio content intended to be consumed by a terminal, referred to as consumer terminal, said content being provided in the form of a stream of audio data time-stamped according to a first time reference, said application being executed according to a second time reference. The device is such that it comprises: means for obtaining audio data of said content, said obtained audio data being time-stamped, on the basis of the second time reference, to indicate respective instants of consumption of said audio data by said consumer terminal; means for determining information on correlation between said obtained audio data and said audio data of said stream; means for determining information on time offset between the first and second time references, according to the determined correlation information and information on time-stamping of the data according to the first and second time references.

The invention also concerns a device comprising an application to be synchronised with an audio content intended to be consumed by a terminal, referred to as consumer terminal, said content being provided in the form of a stream of audio data time-stamped according to a first time reference, said application being executed according to a second time reference. The device is such that it comprises: means for obtaining audio data of said content, said obtained audio data being time-stamped, on the basis of the second time reference, to indicate respective instants of consumption of said audio data by said consumer terminal; and means for transmitting, to a device intended to synchronise said application with the audio content, said audio data obtained and time-stamped on the basis of the second time reference.

The features of the invention mentioned above, as well as others, will emerge more clearly from a reading of the following description of an example embodiment, said description being given in relation to the accompanying drawings, among which:

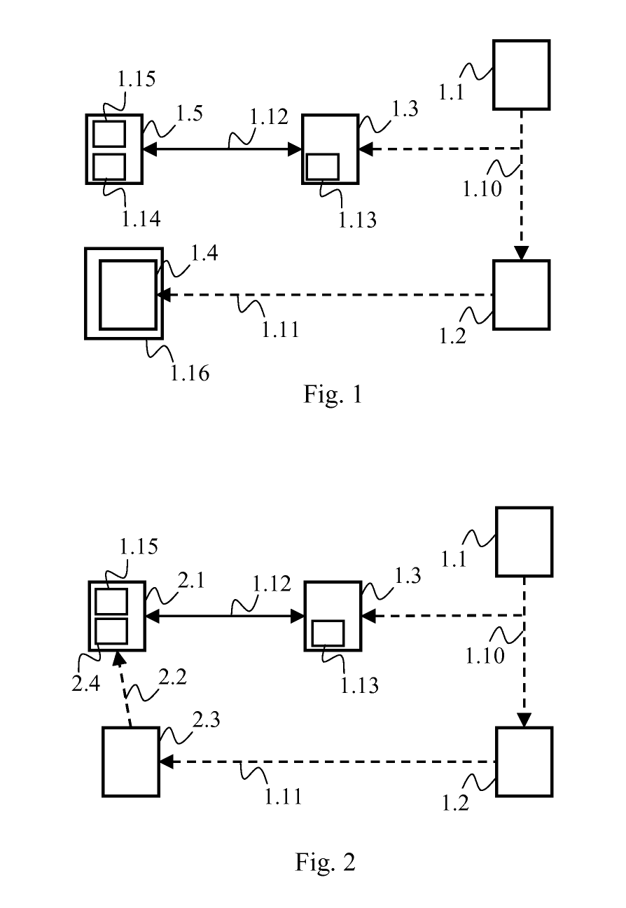

FIG. 1 schematically illustrates a system for synchronising an application to a stream of audio data, according to a first embodiment of the invention;

FIG. 2 schematically illustrates a system for synchronising an application to a stream of audio data, according to a second embodiment of the invention;

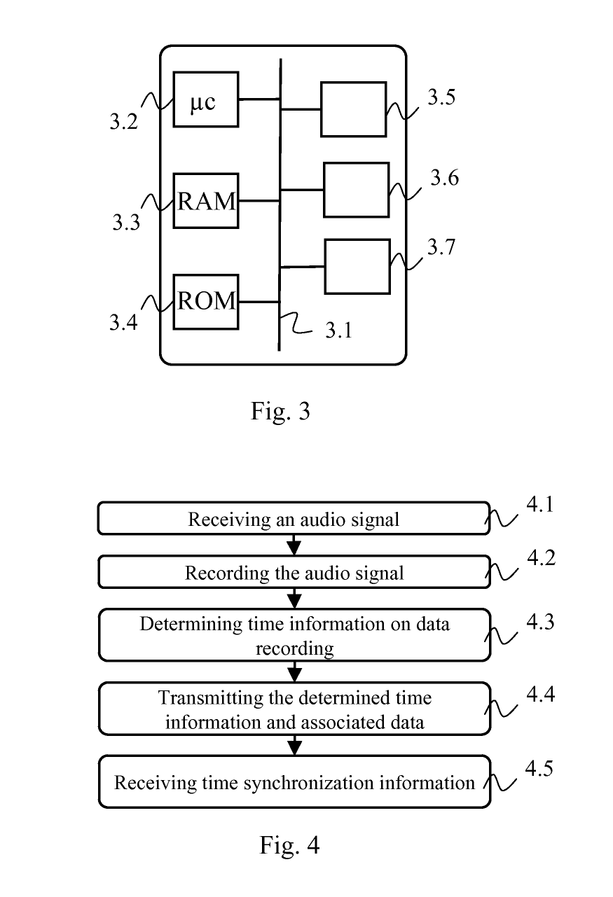

FIG. 3 schematically illustrates an equipment architecture of the synchronisation system, such as a synchronisation service platform or a user terminal, according to one embodiment of the invention;

FIG. 4 schematically illustrates an algorithm used by a user terminal, according to the first embodiment of the invention;

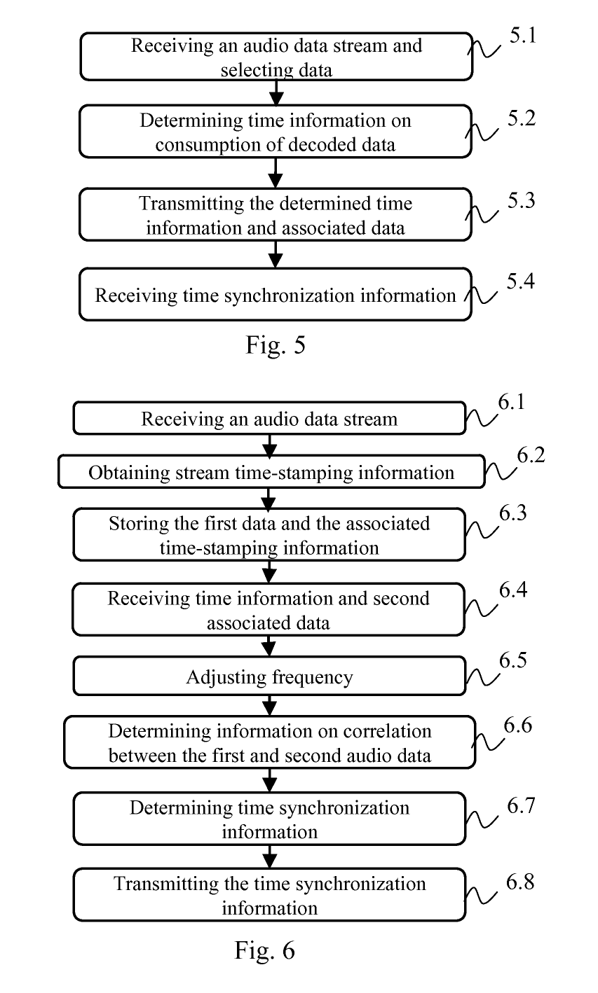

FIG. 5 schematically illustrates an algorithm used by a user terminal according to the second embodiment of the invention;

FIG. 6 schematically illustrates an algorithm used by a synchronisation service platform according to one embodiment of the invention.

So as to synchronise an application installed on a terminal, referred to as interactivity terminal, enabling a user to interact with a stream of data, it is proposed to perform a time-stamping of the audio data corresponding to the instants when these data are consumed by a terminal, referred to as consumer terminal, and for which they are intended. According to a first example, the audio data come from an audiovisual content and the consumer terminal is a screen to which a set-top box supplying the data stream after decoding is connected. According to a second example, the audio data come from an audio content and the consumer terminal is an amplifier, for example intended for home theatre.

The time-stamping information and the audio data with which they are associated, obtained at the interactivity terminal, is then transmitted to a synchronisation service platform that has the same content but with time-stamping performed at the broadcasting network, i.e. upstream of the consumer terminal. The time reference used at the broadcasting network constitutes the first time reference. The synchronisation service platform then performs a correlation between these data and those received from the interactivity terminal in order to determine to which portion of the stream the data received from the interactivity terminal correspond. Once this correlation is made, the time-stamping information enables determining a time offset between the time reference used at the broadcasting network, i.e. the first time reference, and the one used at the interactivity terminal, i.e. the second time reference. This time offset is then used to synchronise the application installed on the interactivity terminal to instants of consumption of the stream by the consumer terminal.

FIG. 1 schematically illustrates a system for synchronising the application to the stream of audio data, according to a first embodiment of the invention.

A source device 1.1, such as a camera or a control room, supplies content comprising audio data via a link 1.10, wired or wireless. The link 1.10 is connected to the synchronisation service platform 1.3 and to broadcasting equipment 1.2, which enables them to receive the data stream supplied by the source 1.1. The broadcasting equipment 1.2 encodes the data stream received via the link 1.10 so as to adapt it for being broadcast to set-top boxes, typically installed in dwellings. The encoding performed by the broadcasting equipment 1.2 is for example in accordance with the terrestrial digital video broadcasting standard DVB-T (Digital Video Broadcasting—Terrestrial), as described in the ETSI specification document EN 300 744 V1.6.1 “Digital Video Broadcasting (DVB); Framing Structure, Channel Coding and Modulation for Digital Terrestrial Television”. The stream thus encoded is then received, in a dwelling, via a link 1.11, by a set-top box 1.4. The set-top box 1.4 is shown in FIG. 1 as integrated in a television screen 1.16. The set-top box 1.4 decodes the stream received via the link 1.11, meaning it performs the reverse operation to that performed by the broadcasting equipment 1.2. It thus recovers the content, the data then no longer being in the form of the time-stamped stream received by the set-top box 1.4. Once decoded, the stream is processed so as to be adapted to be displayed on the screen 1.16, with regard to the video data, and broadcast via loudspeakers with regard to the audio data.

The assembly consisting of the synchronisation service platform 1.3, the broadcasting equipment 1.2, the set-top boxes and optionally the source 1.1 forms the broadcasting network. Each device in the broadcasting network shares the same time reference and their internal clocks are synchronised on this same time reference.

The synchronisation service platform 1.3 comprises an internal clock 1.13 that it uses as a time reference for time-stamping and analysis of the data of the stream received via the link 1.10, as described below in relation to FIG. 6.

The synchronisation system comprises, apart from the synchronisation service platform 1.3, a mobile terminal 1.5 on which the application 1.15 can be launched for interacting with a user according to the content displayed on the screen 1.16 and/or broadcast via the loudspeakers. This mobile terminal 1.5 comprises an internal clock 1.14 that it uses as a time reference for time-stamping the audio data of the stream consumed by the screen 1.16, i.e. broadcast by the loudspeakers, as described below in relation to FIG. 4.

The synchronisation service platform 1.3 and the mobile terminal 1.5 exchange data via a link 1.12, which is for example a connection established via the Internet. These data enable synchronising the application 1.15 with the content displayed on the screen 1.16 and/or broadcast via the loudspeakers, as described below in relation to FIGS. 4 and 6.

The application 1.15 enables using services that may for example be classified in the following way:
services of the “push” type, for presenting on the mobile terminal 1.5 interactive data in close relationship with the content displayed on the screen 1.16 and/or broadcast via the loudspeakers;
services of the “pull” type, enabling the user to request at any time, via the mobile terminal 1.5, data complementary to the content displayed on the screen 1.16 and/or broadcast via the loudspeakers; and
services of the “entertainment” type, enabling the user to reply, via the mobile terminal 1.5, to questions asked along with the content displayed on the screen 1.16 and/or broadcast via the loudspeakers, the mobile terminal 1.5 controlling the response time of the user.

Other classifications can be used, and in particular combinations of the services mentioned above, such as for example services of the “push-pull” type enabling the user to recover on the mobile terminal information present at a given instant in the content displayed on the screen 1.16 and/or broadcast via the loudspeakers.

Thus the data exchanged via the link 1.12 also enable the application 1.15 to manage the interactivity with the user. In other words, these data may correspond to user actions executed via a man-machine interface of the mobile terminal 1.5 or to event notifications transmitted to the application 1.15.

FIG. 2 schematically illustrates a system for synchronising the application to the stream of audio data, according to a second embodiment of the invention. FIG. 2 differs from FIG. 1 in that the set-top box 2.3 is a stand-alone device, meaning it is not integrated in a screen. The set-top box 2.3 is connected to a screen 2.1 via a link 2.2, which enables transmitting the decoded audiovisual data. The link 2.2 conforms for example to the high-definition multimedia interface standard (HDMI), for example in accordance with the document “High Definition Multimedia Interface Specification, Version 1.3, HDMI Licensing LLC, 2006”.

The screen 2.1 comprises an internal clock 2.4, which it uses as a time reference for time-stamping the audio data of the stream that it consumes. The screen 2.1 also comprises the application 1.15. Interactivity with the user is then achieved by means of the screen 2.1, which is substituted for the mobile terminal 1.5 of FIG. 1 in its relationships with the synchronisation service platform 1.3 via the link 1.12. The synchronisation service platform 1.3 and the screen 2.1 exchange data via the link 1.12 to enable synchronising the application 1.15 with the content displayed on the screen 2.1 and/or broadcast via loudspeakers, as described below in relation to FIGS. 5 and 6.

FIG. 3 schematically illustrates, at least partially, the architecture of the mobile terminal 1.5, of the screen 2.1 or of the synchronisation service platform 1.3. This schematic architecture comprises, connected by a communication bus 3.1:
a processor, microprocessor, microcontroller (denoted μc) or CPU (central processing unit) 3.2;
a random access memory (RAM) 3.3;
a read only memory (ROM) 3.4;
a storage medium reader 3.5, such as an SD card (Secure Digital Card) reader or an HDD (Hard Disk Drive);
means (3.6) for interfacing with a communication network, such as for example with the Internet; and
man-machine interface means 3.7, enabling in particular, with regard to the mobile terminal 1.5 and the screen 2.1, to interact with the user.

The microcontroller 3.2 is capable of executing instructions loaded into the RAM 3.3 from the ROM 3.4, from an external memory, from a storage medium or from a communication network. After powering up, the microcontroller 3.2 is capable of reading instructions from the RAM 3.3 and executing them. These instructions form a computer program. This computer program causes the implementation, by the microcontroller 3.2, of all or some of the algorithms described below in relation to FIGS. 4 to 6.

All or some of the algorithms described below in relation to FIGS. 4 to 6 can be implemented in software form by the execution of a set of instructions by a programmable machine, such as a DSP (Digital Signal Processor) or a microcontroller, such as the microcontroller 3.2, or be implemented in hardware form by a dedicated machine or component, such as an FPGA (Field-Programmable Gate Array) or an ASIC (Application-Specific Integrated Circuit).

The synchronisation service platform 1.3 preferentially comprises at least one hard disk drive. The data supplied by the source 1.1 are stored by this hard disk drive and are preferentially organised as a circular buffer. The synchronisation service platform 1.3 can thus store a predefined number of these data or the data corresponding to a predefined consumption period, such as for example the data corresponding to a number N of consecutive seconds of display of video data and broadcasting of associated audio data in an audiovisual stream. As already mentioned, the synchronisation service platform 1.3 performs a step of correlation between data received from the source 1.1 and data received from the mobile terminal 1.5 or from the screen 2.1. It should be noted that the depth of the circular buffer must be sufficiently high so that the data received from the source 1.1 during the correlation step do not overwrite the data of the computing window of the correlation step.

FIG. 4 schematically illustrates an algorithm implemented by the mobile terminal 1.5, according to the first embodiment of the invention illustrated in FIG. 1.

In a step 4.1, the mobile terminal 1.5 receives an audio signal broadcast by the loudspeakers associated with the screen 1.16. In a following step 4.2, the mobile terminal 1.5 performs, by means of a microphone, a recording of a predetermined duration of the audio signal broadcast by the loudspeakers. The mobile terminal 1.5 then digitises the audio signal received. In a following step 4.3, the mobile terminal 1.5 determines, by means of the time reference supplied by the clock 1.14, information on time-stamping of the audio data digitised during the recording performed at step 4.2. The digitised audio data are thus time-stamped by reference to the clock 1.14, this stamping representing, for each data item, the instant at which this data item is consumed by the loudspeakers associated with the screen 1.16. The propagation time of the audio signal in the air is ignored vis-à-vis the possible desynchronisation between the time references, of the broadcasting network on the one hand and of the mobile terminal 1.5 on the other hand. In a variant embodiment, the mobile terminal 1.5 performs a correction of the time-stamping by taking into account a propagation time for the audio signal in the air.

In a following step 4.4, the mobile terminal 1.5 transmits, to the synchronisation service platform 1.3, the digitised data as well as the time-stamping information associated therewith. In a following step 4.5, the mobile terminal 1.5 receives, coming from the synchronisation service platform 1.3, time synchronisation information. This information corresponds to a time offset, determined by the synchronisation service platform 1.3, between the time reference used by the mobile terminal 1.5 and that used at the broadcasting network. This synchronisation information is supplied to the application 1.15 so as to adjust timewise its interactions with the user when the services mentioned in relation to FIG. 1 are used. These interactions are then synchronised timewise with the content displayed by the screen 1.16 and/or broadcast by the loudspeakers that are associated therewith.

FIG. 5 schematically illustrates an algorithm implemented by the screen 2.1, according to the second embodiment of the invention illustrated in FIG. 2.

In a step 5.1, the screen 2.1 receives, via the link 2.2 and coming from the set-top box 2.3, a stream of decoded audiovisual data in order to consume it. The screen 2.1 then selects a segment of the stream of consumed data, corresponding to a predefined consumption duration, such as for example the data corresponding to a number N of consecutive seconds of display of video data and a broadcasting of associated audio data in the audiovisual screen. In a following step 5.2, the screen 2.1 determines, by means of the time reference supplied by the clock 2.4, time-stamping information on the audio data consumed. The audio data consumed are thus time-stamped by reference to the clock 2.4, this stamping representing, for each data item, the instant at which this data item is consumed by the screen 2.1. In this way, the screen 2.1 generates, from the audio content, a stream of audio data time-stamped according to its own time reference.

In a following step 5.3, the screen 2.1 transmits these data to the synchronisation service platform 1.3, as well as the time-stamping information associated therewith. In a following step 5.4, the screen 2.1 receives, coming from the synchronisation service platform 1.3, the time synchronisation information already mentioned in relation to FIG. 4.

FIG. 6 schematically illustrates an algorithm implemented by the synchronisation service platform 1.3, according to one embodiment of the invention.

In a step 6.1, the synchronisation service platform 1.3 receives data of a stream via the link 1.10. In a following step 6.2, the synchronisation service platform 1.3 obtains time-stamping information on the stream. This time-stamping information is generated on the basis of the time reference of the broadcasting network. This time-stamping information is for example inserted by the source 1.1. In a variant embodiment, this time-stamping information is generated by the synchronisation service platform 1.3, by means of its clock 1.13. In this case, the broadcasting equipment 1.2 generates in the same way time-stamping information on the basis of its internal clock, before transmitting it via the link 1.11, the internal clocks of the devices of the broadcasting network being synchronised on the same time reference.

In a following step 6.3, the synchronisation service platform 1.3 stores the received data, as well as the associated time-stamping information. These data are non-noisy and constitute the reference stream for implementing the already-mentioned correlation step.

In a following step 6.4, the synchronisation service platform 1.3 receives audio data and associated time-stamping information, this time-stamping information corresponding to the instant where the associated audio data were consumed by the terminal for which they are intended, i.e. the consumer terminal. These audio data and time-stamping information correspond, in the embodiments described in relation to FIGS. 4 and 5, respectively to what is transmitted by the mobile terminal 1.5 in step 4.4 and by the screen 2.1 in step 5.3.

In a following optional step 6.5, the synchronisation service platform 1.3 performs a frequency adjustment of the data stored at steps 6.3 and/or those received at step 6.4. The step of correlation between these data having to be performed on audio data sampled at the same frequency, a target frequency is chosen. For example, this frequency is chosen at 8 kHz. In the case where the sampling frequency of the data stored at step 6.3 and/or of those received at step 6.4 differs from the target frequency, a step of re-sampling to this target frequency is performed.

In a following step 6.6, the synchronisation service platform 1.3 performs the correlation step, meaning it determines information on correlation between the data stored at 6.3 and those received at step 6.4. The correlation step consists of determining to which portion of the stream received from the source 1.1 the data received at step 6.4 correspond. To do this, a matched filter, also referred to as a North filter, can be applied. The matched filter is then formed on the basis of the audio data received at step 6.4, reversed in time. The use of such a filter advantageously enables maximising the signal-to-noise ratio, in particular when the data received at step 6.4 come from the recording made by the mobile terminal 1.5 at step 4.2. It is also possible to use techniques of generation and comparison of audio fingerprints. Such fingerprints are generated for the audio data received at step 6.4 and are compared with fingerprints generated in a similar fashion for the audio data received at step 6.1, i.e. time-stamped according to the first time reference.

The synchronisation service platform 1.3 may also implement a step of validating the results of the correlation step, so as to verify the temporal coherence thereof.

In a following step 6.7, once the synchronisation service platform 1.3 has determined the positioning of the audio data received at step 6.4 among the audio data stored at step 6.3, it determines time synchronisation information representing the time offset between the time reference used by the broadcasting network and that used by the interactivity terminal, i.e. the one on which the application 1.15 is launched.

In a following step 6.8, the synchronisation service platform 1.3 transmits the time synchronisation information determined at step 6.7 to the interactivity terminal. The time synchronisation information is then exploited, or taken into account, at this interactivity terminal.

Thus, when the synchronisation service platform 1.3 receives the data of the stream, as indicated during step 6.1, it is in a position to detect events inscribed in the stream, with time-stamping information associated with these events. The synchronisation service platform 1.3 may thus propagate this event to all the applications 1.15 for which the correlation step has been implemented and for which the synchronisation information coming from step 6.7 is available. The applications 1.15 are then in a position to match the time-stampings to these events by means of the synchronisation information available to them respectively. This enables the synchronisation service platform 1.3 to transmit each event in the form of the same notification, identical for each application 1.15. Alternatively, this enables managing the events transmission by a device other than the synchronisation service platform 1.3, such as for example the broadcasting equipment 1.2. The processing load of the synchronisation service platform 1.3 is thus lowered.

In a variant embodiment, the time synchronisation information is exploited, or taken into account, at the synchronisation service platform 1.3. The synchronisation information is then not transmitted to the applications 1.15. When the synchronisation service platform 1.3 detects an event in the stream, it matches the associated time-stamping to the event by taking into account the synchronisation information determined at step 6.7, and this for each application 1.15. The synchronisation service platform 1.3 then transmits to each application 1.15 an event notification, the time-stamping information of which is matched to the concerned application 1.15.

The events are notified to the interactivity terminals by indication of the value of the time reference at which this event must take place in the interactivity terminal, this time value being able to be determined either with respect to the first time reference (the case of a generic notification) or with respect to the second time reference (the case of a particular notification to each interactivity terminal). These notifications may a priori be transmitted to the terminals in various forms, such as for example dedicated messages distinct from the frames encapsulating the audiovisual data, dedicated fields included directly in the frames encapsulating the audiovisual data, or any other signalling means. The events may be supplied by the source 1.1 or by a dedicated device placed, on the link 1.10, downstream of the source 1.1 and upstream of the synchronisation service platform 1.3 and the broadcasting equipment 1.2.

The correspondence between time references is established for the audio data. In the case where the time references used for the audio and video data are distinct, and the events are linked to the video data, each application 1.15 and/or the synchronisation service platform 1.3 are in a position to determine the offset between these time references. It is sufficient to compare the time-stampings of a video data item and an associated audio data item in the audiovisual stream to determine this offset. Thus the difference between these time references, combined with the synchronisation information determined at step 6.7, enables managing, in a synchronised manner, events related to the video data.

Once the time offset between the time reference of the broadcasting network and that of the terminal on which the application 1.15 is launched has been determined, mechanisms for correcting a drift between the time references can be used. The execution of a new synchronisation operation can then be initiated:
either by the user of the terminal on which the application 1.15 is launched, for example when a visible time offset between the interactive data displayed by this terminal and the content to which they refer is detected;
or by the synchronisation service platform 1.3, for example at regular intervals or following the expiry of a time delay.

In addition, desynchronisations may appear when switching from one content to another, i.e. from one stream to another, on the set-top box 1.4 or 2.3. It is then possible to reiterate the synchronisation operation. This may be done upon detection of the start of a stream in the set-top box or the start of the consumption of a stream by the consumer terminal. This detection of a start of stream decoding, for example resulting from a television program change performed by the user, may result from:
notifications generated by the set-top box 1.4 or 2.3;
specific processing operations performed by the consumer terminal, by detection of discontinuity of the audiovisual signal;
the interactivity terminal itself, in the case where it serves as a remote control for the set-top box 1.4 or 2.3.

The time synchronisation information is then modified accordingly.

In order to correct the time synchronisation information determined at step 6.7, it is possible to determine the correspondence between the time reference used by the broadcasting network and a time reference used by the set-top box, and then to determine subsequently the drift of such a correspondence when switching from one stream to another. It is then possible to adjust the time synchronisation information determined at step 6.7 by means of the determined drift.

According to another embodiment, the consumer terminal has two modes for receiving a same content. The consumer terminal is then adapted to receive two flows, corresponding to the same content, by two different means. For example, a first stream may be received in a broadcast manner, coming from the broadcasting equipment 1.2, and a second stream is received, in a point-to-point manner, via the Internet. These two streams then have time-stampings performed on the basis of distinct time references. The correlation operation can then be implemented so as to determine the time offset between these two streams. Information for correlating a segment of one of these two streams with the other stream are determined so as to determine time synchronisation information, i.e. a time offset between the two references, in the same way as at steps 6.6 and 6.7. This time offset information can then be used to enable synchronised switching from one stream to another, meaning transparently for the user. Such a switching is for example useful when the consumer terminal is a mobile terminal and the user enters a geographical area not covered according to one of the two reception modes.

1. A system for synchronising an application, with an audio content intended to be consumed by a terminal, referred to as consumer terminal, said content being provided in the form of a stream of audio data time-stamped according to a first time reference, said application being executed according to a second time reference where said system comprises:
means for obtaining audio data of said content, said obtained audio data being time-stamped, on the basis of the second time reference, so as to indicate respective instants of consumption of said audio data by said consumer terminal;
means for determining information on correlation between said obtained audio data and said audio data of said stream;
means for determining information on time offset between the first and second time references, according to the determined correlation information and information on time-stamping of the data according to the first and second time references;
means for synchronising the application with said content, on the basis of the determined time offset information.

2. The system according to claim 1, wherein the application is executed on a terminal distinct from the consumer terminal and in that said means for obtaining audio data on said content comprise means for recording part of the audio content consumed by the consumer terminal.

3. The system according to claim 1, wherein the consumer terminal is connected to a device comprising means for recovering said content from said stream of audio data time-stamped according to the first time reference, wherein the application is executed on the consumer terminal and wherein the consumer terminal comprises means for generating, from said audio content, a stream of audio data time-stamped according to the second time reference.

4. The system according to claim 1, wherein said system comprises means for re-sampling the audio data obtained and/or the audio data of said stream to a target frequency.

5. The system according to claim 1, wherein said means for synchronising the application with said content comprise means for taking account of said time offset information by said application.

6. The system according to claim 1, wherein said means for synchronising the application with said content comprise means for taking account of said time offset information by a device transmitting to said application events relating to said content.

7. The system according to claim 1, wherein the means for determining correlation information comprise a matched filter, based on a time reversal of said obtained audio data, or means for generating audio fingerprints from said obtained data and the data of said stream and for comparing the generated fingerprints.

8. The system according to claim 1, wherein said system comprises means for modifying the time offset information upon detecting a start of stream decoding.

9. The system according to claim 1, wherein said audio content forms part of an audiovisual content.

10. A method for synchronising an application, with an audio content intended to be consumed by a terminal, referred to as consumer terminal, said content being provided in the form of a stream of audio data time-stamped according to a first time reference, said application being executed according to a second time reference, characterised in that it comprises steps of:
obtaining audio data of said content, said obtained audio data being time-stamped, on the basis of the second time reference, so as to indicate respective instants of consumption of said audio data by said consumer terminals;
determining information on correlation between said obtained audio data and said audio data of said stream;
determining information on time offset between the first and second time references, according to the determined correlation information and information on time-stamping of the data according to the first and second time references; and
synchronising the application with said content, on the basis of the determined time offset information.

11. A device adapted for determining offset information intended to synchronise an application with an audio content intended to be consumed by a terminal, referred to as consumer terminal, said content being provided in the form of a stream of audio data time-stamped according to a first time reference, said application being executed according to a second time reference, wherein said device comprises:
means for obtaining audio data of said content, said obtained audio data being time-stamped, on the basis of the second time reference, so as to indicate respective instants of consumption of said audio data by said consumer terminals;
means for determining information on correlation between said obtained audio data and said audio data of said stream; and
means for determining information on time offset between the first and second time references, according to the determined correlation information and information on time-stamping of the data according to the first and second time references.

12. A device comprising an application to be synchronised with an audio content intended to be consumed by a terminal, referred to as consumer terminal, said content being provided in the form of a stream of audio data time-stamped according to a first time reference, said application being executed according to a second time reference, wherein said device comprises:
means for obtaining audio data of said content, said obtained audio data being time-stamped, on the basis of the second time reference, so as to indicate respective instants of consumption of said audio data by said terminal; and
means for transmitting, to a device intended to synchronise said application with the audio content, said audio data obtained and time-stamped on the basis of the second time reference.
